(19) United States
(12) Patent Application Publication
(10) Pub. No.: US 2018/0164570 A1
(43) Pub. Date: Jun. 14, 2018

(54) MICROSCOPE DEVICE, STORAGE MEDIUM AND OBSERVATION METHOD

(71) Applicant: OLYMPUS CORPORATION, Tokyo (JP)

(72) Inventor: Yosuke TANI, Tokyo (JP)

(73) Assignee: OLYMPUS CORPORATION, Tokyo (JP)

(21) Appl. No.: 15/822,717

(22) Filed: Nov. 27, 2017

(30) Foreign Application Priority Data
Dec. 14, 2016 (JP) 2016-242711

(51) Int. Cl. G02B 21/36; G02B 21/00; G06T 5/50

(52) U.S. Cl. CPC G02B 21/367; G06T 2207/20221; G06T 5/50; G02B 21/008

(57) ABSTRACT

A microscope device 10 includes a color camera 4 that obtains an observation image, and a control device 20 functioning as an image process device that performs, in a state in which the color camera 4 is obtaining the observation images under a particular observation condition, a mapped image generation process in which the obtained observation images are combined so as to generate a mapped image, halts the mapped image generation process when the state transitions to a state that is an observation condition other than the particular observation condition from the state, and restarts the mapped image generation process when the state again transitions to a state in which the color camera 4 is obtaining the observation images under the particular observation condition.

### CROSS REFERENCE TO RELATED APPLICATIONS

This application is based upon and claims the benefit of priority from prior Japanese Patent Application No. 2016-242711, filed Dec. 14, 2016, the entire contents of which are incorporated herein by this reference.

### BACKGROUND OF THE INVENTION

### Field of the Invention

The present invention is related to a microscope device, a program and an observation method that generate a mapped image.

### Description of the Related Art

Conventionally, a technique of generating a large mapped image by combining a plurality of obtained images is known as an observation technique for microscopes (Japanese National Publication of International Patent Application No. 2001-519944). Techniques like this make it possible to generate an image of a region that is wider than the field of view of the objective provided to the microscope, realizing observations of characteristics of the sample in a wide scope.

### SUMMARY OF THE INVENTION

A microscope device according to one aspect of the present invention includes an image pickup device that obtains an observation image of a sample, and an image process device that performs, in a state in which the image pickup device is obtaining the observation images under a particular observation condition, a mapped image generation process in which the plurality of observation images obtained under the particular observation condition are combined so as to generate a mapped image, halts the mapped image generation process when the state transitions to a state that is an observation condition other than the particular observation condition from the state in which the image pickup device is obtaining the observation images under the particular observation condition, and restarts the mapped image generation process when the state again transitions to a state in which the image pickup device is obtaining the observation images under the particular observation condition.

A program according to one aspect of the present invention causes a computer to execute a process of making an image pickup device and an image process device operate so that the image pickup device obtains an observation image of a sample, and the image process device performs, in a state in which the image pickup device is obtaining the observation images under a particular observation condition, a mapped image generation process in which the plurality of observation images obtained under the particular observation condition are combined so as to generate a mapped image, halts the mapped image generation process when the state transitions to a state that is an observation condition other than the particular observation condition from the state in which the image pickup device is obtaining the observation images under the particular observation condition, and restarts the mapped image generation process when the state again transitions to a state in which the image pickup device is obtaining the observation images under the particular observation condition.

An observation method according to one aspect of the present invention includes obtaining an observation image of a sample, and performing, in a state in which the observation images are being obtained under a particular observation condition, a mapped image generation process in which the plurality of observation images obtained under the particular observation condition are combined so as to generate a mapped image, halting the mapped image generation process when the state transitions to a state that is an observation condition other than the particular observation condition from the state in which the image pickup device is obtaining the observation images under the particular observation condition, and restarting the mapped image generation process when the state again transitions to a state in which the observation images are being obtained under the particular observation condition.

### BRIEF DESCRIPTION OF THE DRAWINGS

The present invention will be more apparent from the following detailed description when the accompanying drawings are referenced.

FIG. 1 illustrates a configuration of a microscope device according to the first embodiment;

FIG. 2 illustrates a configuration of a control device according to the first embodiment;

FIG. 3 illustrates a functional configuration of the control device according to the first embodiment;

FIG. 4 illustrates a mapped image generated by a process of an image process unit;

FIG. 5 is a flowchart illustrating a process sequence in which a control device generates a mapped image;

FIG. 6 illustrates a state in which a mapped image that is in the middle of being generated is being output to a display medium; and

FIG. 7 illustrates a configuration of a microscope device according to the second embodiment.

### DESCRIPTION OF THE EMBODIMENTS

Conventionally, when the settings of a microscope device are to be changed while a mapped image is being generated, it has been necessary to interrupt the generation process of the mapped image depending upon the contents of the change in the settings. Examples of changes in settings that interrupt the generation process of a mapped image include switching of the optical system and changes in the exposure time, the magnification, etc. Another example of these changes is a change in settings that makes it impossible to obtain an image appropriate for constituting the mapped image that is currently being generated (hereinafter such a change in the settings of a microscope device will be referred to as a change in observation conditions).

When for example the magnification is changed during the generation process of a mapped image, an image obtained in a state in which the magnification has been changed (an image that is not an image for constituting the mapped image) is used for generating the mapped image, leading to an abnormal mapped image. In other words, it becomes impossible to obtain images for constituting the mapped image that is currently being generated, leading to the necessity for the interruption of the mapped image generation process.

Also, in a microscope provided with a plurality of optical systems such as a confocal laser scanning optical system and a color observation optical system, only one of such optical systems (the color observation optical system in this example) is often used for generating a mapped image. In other words, in the case when the optical system is switched while generating a mapped image as well, it becomes impossible to obtain an image for constituting the mapped image that is currently being generated, leading to the necessity for the interruption of the mapped image generation process.

Also, observers have conventionally performed the manipulations of interrupting and starting mapped image generation processes or other manipulations, which are to be performed each time such changes are made in observation conditions. This has made it necessary for observers to frequently give instructions to interrupt and restart the mapped image generation processes each time the above switching of magnifications, optical systems, etc. is conducted, causing a problem of troublesome manipulations.

Thus, it is an object of the present invention to reduce manipulation burdens on the observer that accompany changes in observation conditions during the generation of a mapped image.

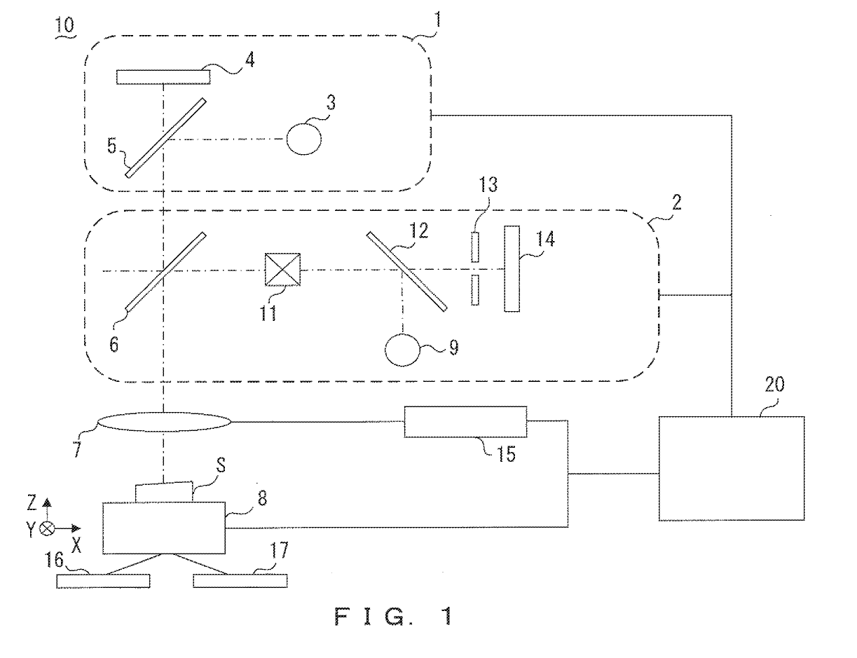

Hereinafter, explanations will be given for a microscope device 10 according to the first embodiment of the present invention by referring to the drawings. FIG. 1 illustrates a configuration of the microscope device 10.

The microscope device 10 includes a color observation optical system 1 and a confocal laser scanning optical system 2, which are two different optical systems, an objective 7, a stage 8 that mounts and fixes sample S, drive motors 15 and 17, a stage position detection mechanism 16 and a control device 20.

The color observation optical system 1 includes a white-light source 3, a color camera 4 and a half mirror 5. When the color observation optical system 1 is used for observations, illumination light issued from the white-light source 3 is reflected by the half mirror 5 and is cast on sample S via the objective 7. The light reflected by sample S passes through the same optical path as that of the illumination light and is detected by the color camera 4, and thereby a color bright-field-of-view observation image is obtained.

The color camera 4 is an image pickup device (first image pickup device) that detects the reflection light from sample S and obtains an observation image of sample S. Observation images obtained by the color camera 4 will also be referred to as first observation images. A CCD camera, a CMOS image sensor, etc. may be used as the color camera 4.

The confocal laser scanning optical system 2 includes a laser light source 9, a half mirror 12, a 2D scanner 11, a dichroic mirror 6, a pin hole 13 and an optical detector 14. The dichroic mirror 6 reflects illumination light from the laser light source 9 and transmits illumination light from the white-light source 3. The pin hole 13 is arranged on a plane that is substantially conjugate with the focal plane of the objective 7, and transmits only light generated on the focal plane of the objective 7. Also, the 2D scanner 11 is a unit that changes the angle of the light beam of the illumination light in the optical path of the confocal laser scanning optical system 2 and thereby scans the illumination light on the X-Y plane of sample S. As the 2D scanner 11, a galvano scanner etc. for example may be used.

When an observation is to be conducted by using the confocal laser scanning optical system 2, illumination light issued from the laser light source 9 is reflected by the half mirror 12 and the dichroic mirror 6 and is cast on sample S via the 2D scanner 11 and the objective 7. From among the beams of the light that was reflected by sample S that reach the pin hole 13 after passing through the same optical path as that of the illumination light and after being transmitted by the half mirror 12, only light beams that passed through the pin hole 13 are detected by the optical detector 14 while scanning the illumination light by using the 2D scanner 11. Accordingly, when observations are conducted by using the confocal laser scanning optical system 2, monochrome confocal images are obtained.

The optical detector 14 is an image pickup device (second image pickup device) that detects reflection light from sample S and obtains an observation image of sample S. Observation images obtained by the optical detector 14 will also be referred to as second observation images. As the optical detector 14, a PMT etc. may be used.

The objective 7 is connected to the drive motor 15. The drive motor 15 operates under control of the control device 20 and changes the focal position of illumination light in the Z-axial directions by moving the objective 7 in the directions of the optical axis of the objective. When an observation is performed by using the confocal laser scanning optical system 2, images can be obtained in three dimensions, including the X, Y and Z directions, by changing the focal position of illumination light in the Z-axial directions through the movements of the objective 7 caused by the drive motor 15 in addition to the operations of the 2D scanner 11.

Also, a revolver that includes a plurality of objectives and can switch the objective 7 that is arranged in the optical path so as to be used from among the plurality of the objectives may be provided.

The stage 8 mounts and fixes sample S and is connected to the stage position detection mechanism 16 and the drive motor 17.

The stage position detection mechanism 16 detects the position information of the stage 8. The stage position detection mechanism 16 reads for example the value of the scale provided to the stage 8 and outputs that value to the control device 20 as position information.

The drive motor 17 moves the stage 8 in the X, Y and Z directions, and thereby changes the cast position of the illumination light in the X, Y and Z directions. When an observation is performed by using the color observation optical system 1, the cast position of the illumination light can be changed through the movements of the stage 8 that are caused by the drive motor 17.

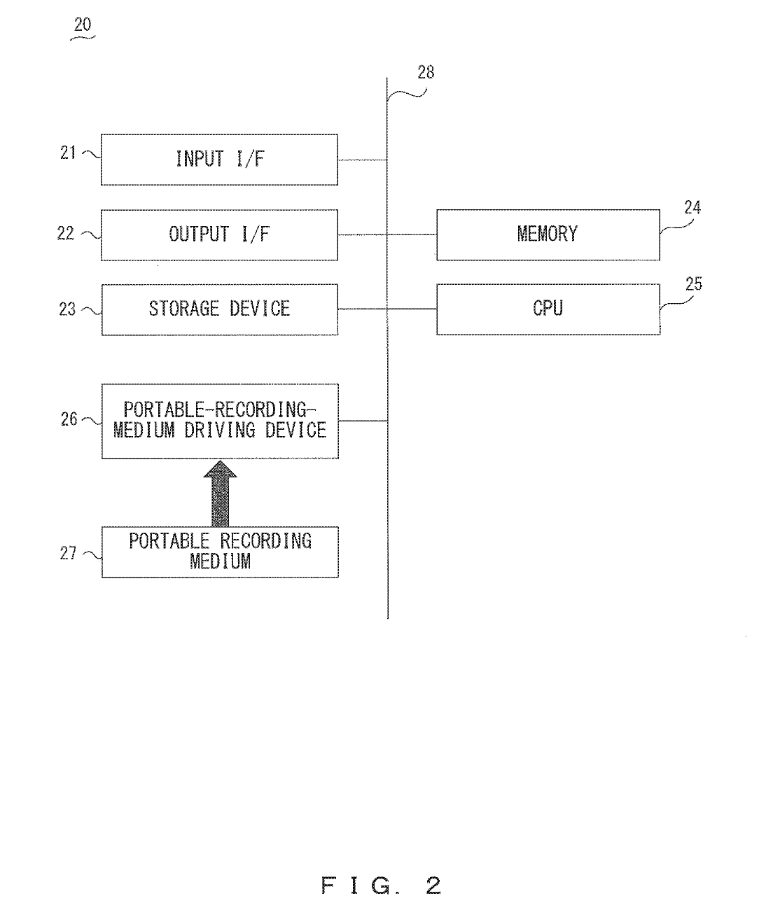

The control device 20 is a computer that controls respective constituents of the microscope device 10. FIG. 2 illustrates a configuration example of the control device 20.

The control device 20 includes for example an input interface (input I/F) 21, an output interface (output I/F) 22, a storage device 23, a memory 24, a CPU 25, and a portable-recording-medium driving device 26, and they are connected to each other via a bus 28.

The CPU 25 executes a program by using the memory 24. By the CPU 25 executing a program, the control device 20 functions as a control device that controls respective constituents of the microscope device 10, as a detection device that detects that it is a particular observation condition during an observation, and as an image process device that performs processes of performing, halting and restarting a mapped image generation process and other processes. The memory 24 is for example a semiconductor memory such as a Read Only Memory (ROM), a Random Access Memory (RAM), etc. The storage device 23 is a non-transitory storage medium, and may be for example a magnetic disk device or a hard disk drive. Note that the storage device 23 may also be a tape device or may be a semiconductor memory such as a flash memory etc. The storage device 23 stores a program, observation image data, mapped image data, etc. A program, observation image data and mapped image data stored in the storage device 23 are loaded onto the memory 24 and are used.

The portable-recording-medium driving device 26 is a device that drives a portable recording medium 27, and accesses contents recorded in the portable recording medium 27. Examples of the portable recording medium 27 include a semiconductor device (USB memory etc.), a medium to/from which information is input or output through magnetic effects (such as a magnetic disk etc.), a medium to/from which information is input or output through optical effects (such as a CD-ROM, a DVD, etc.), etc. The portable recording medium 27 may store a program, observation image data, mapped image data, etc. A program, observation image data and mapped image data stored in the portable recording medium 27 may be loaded onto the memory 22 and used.

The output I/F 22 is an interface that outputs observation image data and mapped image data as an image signal to a display medium (not illustrated) such as a monitor device etc. The input I/F 21 is for example an interface that receives data from an input device (not illustrated) such as a keyboard, a mouse, etc., and receives inputs from the observer.

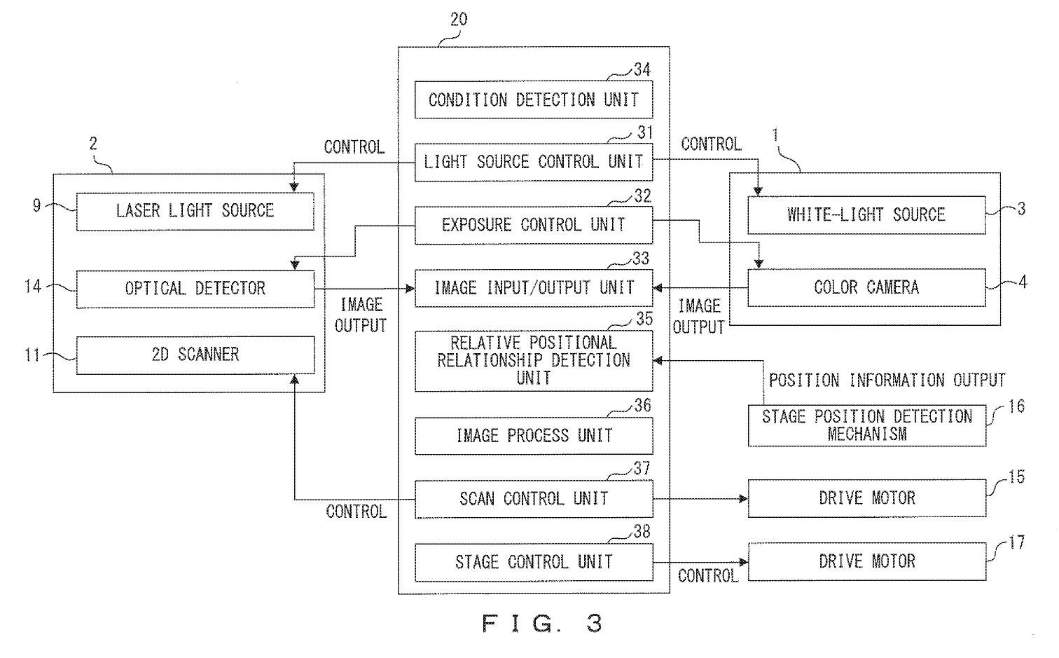

FIG. 3 is a functional configuration diagram of the control device 20. The control device 20 is a control device that controls respective constituents of the microscope device 10, and includes a light source control unit 31, an exposure control unit 32, an image input/output unit 33, a condition detection unit 34, a relative positional relationship detection unit 35, an image process unit 36, a scan control unit 37 and a stage control unit 38.

The light source control unit 31 performs ON/OFF controls for the white-light source 3 and the laser light source 9. It may also control the switching etc. of the wavelengths of light used by the white-light source 3 and the laser light source 9.

The exposure control unit 32 controls the exposures of the color camera 4 and the optical detector 14. Specifically, through the control of the light source control unit 31 and the exposure control unit 32, whether to use either of the color observation optical system 1 and the confocal laser scanning optical system 2 or to use both of them for picking up an image of sample S is selected. The selection of the optical system to use is performed by detecting inputs from the observer.

The image input/output unit 33 receives an image signal (which is observation image data of sample S) from the color camera 4 and the optical detector 14, and outputs the image data to a display medium (not illustrated). Image data output from the image input/output unit 33 is mapped image etc. generated by the image process unit 36, which will be described later.

The condition detection unit 34 detects that the condition is a particular observation condition. An observation condition is a condition that is determined depending upon the setting and the operation status in the microscope device 10, and a particular observation condition is a certain fixed condition, among observation conditions, that triggers the execution, by the image process unit 36, of a mapped image generation process. In the present embodiment, the particular observation condition is that the color camera 4, which is the first image pickup device, is obtaining first observation images, which are observation images, by using the color observation optical system 1. By for example detecting an input related to the selection of the optical system to use, the condition detection unit 34 detects a particular observation condition, i.e., in this example, that the color camera 4 is obtaining observation images.

Note that a particular observation condition is an observation condition that is determined depending upon the setting and the operation status in the microscope device 10, and may be an arbitrary condition as long as it is appropriate for generating a mapped image, without being limited to the above condition. For example, a particular observation condition may be that observation images are being obtained with a particular magnification. When a particular observation condition is that observation images are being obtained with a particular magnification, the condition detection unit 34 may detect that particular observation condition by detecting an input of magnification switching from the observer. Note that magnification switching referred to herein includes both of switching between types of the objectives 7 and digital zooming conducted on an obtained observation image. Also, when the observer changes the magnification by manually switching the objective 7, a sensor that detects switching between the objectives 7 may be provided so as to detect whether or not the condition is a particular observation condition by receiving a signal from that sensor. Also, a particular observation condition may be a combination between a plurality of observation conditions, and for example a particular observation condition may include that observation images are being obtained by using the color observation optical system 1 and that observation images are being obtained with a particular magnification.

The relative positional relationship detection unit 35 detects a relative positional relationship between sample S and the objective 7. The relative positional relationship is a relative position of sample S with respect to the objective 7, and is recorded as position coordinates on a specified coordinate system (which will be referred to as an observation coordinate system). Note that while the observation coordinate system may include the coordinate information of each of the X, Y and Z directions, it is sufficient in this example if it includes the coordinate information of the X and Y directions. A relative positional relationship is determined for example on the basis of the position information of the stage 8 detected by the stage position detection mechanism 16.

Note that a relative positional relationship may be detected by treating a common characteristic in an overlapping region of two or more obtained observation images as a template and performing a pattern matching process in which the two or more observation images are arranged in an overlapping manner. Specifically, by arranging observation images having an overlapping portion on a virtual coordinate system (a mapped image coordinate system, which will be described later) in the control device 20 in such a manner that the templates coincide, the relative positional relationship of two observation images is understood.

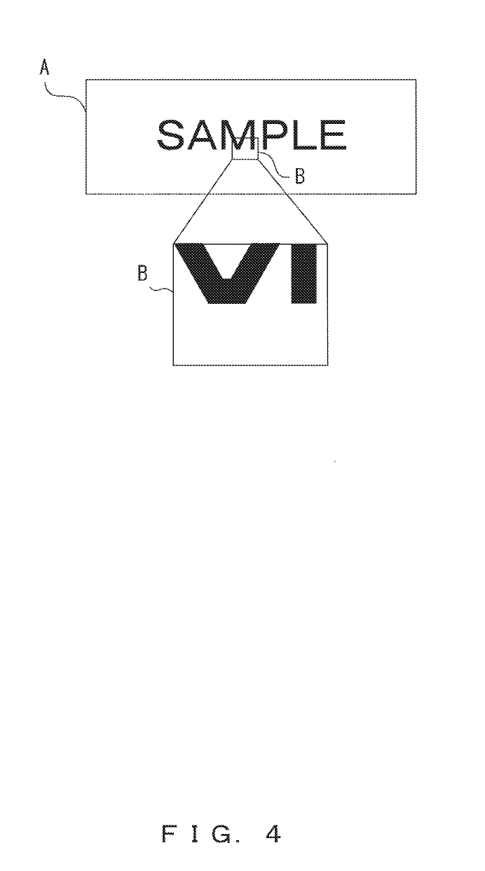

The image process unit 36 performs a process of generating a mapped image by combining a plurality of observation images (first observation images) obtained by the color camera 4, which is the first image pickup device. FIG. 4 illustrates a mapped image generated by a process performed by the image process unit 36. Mapped image A is an image generated by combining a plurality of observation images B, which are observation images obtained in the field of view of the objective 7. Generating mapped image A like this makes it possible to provide the observer with an image that has information of sample S in a much wider scope than that of a single observation image B.

A mapped image as described above is generated on the basis of for example observation images, a relative positional relationship and a relative relationship between the observation coordinate system, which is the coordinate system defining the relative positional relationship, and the mapped image coordinate system. Generating a mapped image in the above manner will be referred to as a mapped image generation process or a generation process of a mapped image. A mapped image coordinate system is a coordinate system on which observation images are arranged when observation images are combined. A relative relationship associating the mapped image coordinate system and the observation coordinate system is stored in the control device 20 in advance. In other words, observation images obtained in respective relative positional relationships are arranged on the mapped image coordinate system on the basis of the relative relationships between the mapped image coordinate system and the observation coordinate system so as to generate one mapped image.

Also, when a relative positional relationship is detected by using a pattern matching process instead of the position information of the stage 8, a generation process of a mapped image is performed for example as below in the image process unit 36. For generating a mapped image, the observation image obtained first is arranged on the coordinate system of the mapped image. Thereafter, a plurality of observation images are obtained so that they have an overlapping region from which a template serving as a common characteristic is obtained and the observation images are arranged on the mapped image coordinate system by a pattern matching process, and thereby one mapped image is generated. In a generation process of a mapped image as described above, a relative positional relationship that determines the position of each observation image is detected in the course of arranging the observation images on the mapped image coordinate system through a pattern matching process.

Also, relative positional relationships may be detected by combining the position information of the stage 8 and a pattern matching process. In such a case, the image process unit 36 detects relative positional relationships on the basis of the position information of the stage 8 detected by the stage position detection mechanism 16, and arranges, on the mapped image coordinate system, observation images obtained with respective relative positional relationships, on the basis of the relative relationship between the mapped image coordinate system and the observation coordinate system. Thereafter, the image process unit 36 further performs a pattern matching process on a plurality of observation images arranged on the mapped image coordinate system (i.e., observation images constituting the mapped image) so as to correct the relative positional relationships of the plurality of observation images. By arranging observation images on the mapped image coordinate system on the basis of the position information of the stage 8 as described above and thereafter performing a pattern matching process, it becomes possible to generate a more reliable mapped image in which positional shifts etc. between observation images are corrected.

In this example, the image process unit 36 is characterized in that the above mapped image generation process is performed under a particular observation condition. More specifically, the image process unit 36 performs a mapped image generation process, which generates a mapped image by combining a plurality of observation images obtained under a particular observation condition, in a state in which the image pickup device is obtaining the observation images under the particular observation condition. The image pickup device referred to herein is the color camera 4, which is the first image pickup device, i.e., the image pickup device that obtains observation images used for generating a mapped image. Further, the image process unit 36 halts a mapped image generation process when the state transitions to a state that is an observation condition other than a particular observation condition, and restarts the mapped image generation process when the state again transitions to a state in which the image pickup device (image pickup device that obtains observation images used for generating a mapped image) is obtaining observation images under a particular observation condition. Note that an observation condition other than a particular observation condition is an observation condition that is not a particular observation condition and is, in the present embodiment, a case in which for example images are only being obtained by the optical detector 14 of the confocal laser scanning optical system 2 without the use of the color camera 4 of the color observation optical system 1. In other words, the control device 20 having the image process unit 36 functions as an image process device that automatically performs or halts a generation process of a mapped image depending upon whether the microscope device 10 is under a particular observation condition or under a condition other than a particular observation condition.

Also, the restarting of a mapped image generation process referred to in this example means performing a mapped image generation process in such a manner that obtained observation images are arranged on the same mapped image coordinate system for the mapped image that had been generated before the halt and thereby the mapped image that had been generated before the halt is updated.

Having this function makes it possible, even when the condition is changed to an observation condition that is not appropriate for generating a mapped image during the generation of the mapped image, to automatically prevent a situation where observation images obtained under that condition are used for generating a mapped image.

Also, even when the observer does not perform a manipulation in which they determine whether or not the condition is an observation condition that is appropriate for generating a mapped image (particular observation condition) so as to make an input for halting or restarting the generation of the mapped image, the determination of the generation and half of the mapped image and the processes for it are automatically performed. This makes it possible for the observer to make a device perform determination and manipulations accompanying the generation of a mapped image after giving an instruction one time to generate the mapped image and before the completion of the generation of the mapped image, leading to reduction in manipulation burdens on the observer.

A case is assumed for example in which a state with the color camera 4 obtaining observation images is treated as a particular observation condition. In this case, when the optical system used by the observer is switched from the color observation optical system 1 to the confocal laser scanning optical system 2 during the generation of a mapped image, the image process unit 36 automatically halts the mapped image generation process. Also, when the optical system to use is again switched to the color observation optical system 1, the image process unit 36 automatically restarts the mapped image generation process. Accordingly, even when the observer temporarily switches to the confocal laser scanning optical system 2 while the microscope device 10 is generating a mapped image by using the color observation optical system 1, the image process unit 36 automatically determines whether to halt or restart the mapped image generation process, leading to reduction in manipulation burdens on the observer.

The same process is performed by the image process unit 36 also in a case when a state in which observation images are being obtained with a particular magnification is treated as a particular observation condition. For example, when a change is made to obtain observation images with a magnification other than a particular magnification, the image process unit 36 automatically halts the mapped image generation process. Also, when the state again changes to a state in which observation images are obtained with a particular magnification, the image process unit 36 automatically restarts the mapped image generation process. Accordingly, even when the observer temporarily changes the magnification for the observation while the microscope device 10 is generating a mapped image by using observation images obtained with a particular magnification, the image process unit 36 automatically determines whether to halt or restart the mapped image generation process and performs the process for it, leading to reduction in manipulation burdens on the observer.

As a general rule, when the magnification is changed while observation images used for generating the mapped image are being obtained, images that are not inherently images to be combined (not images obtained with the same magnification) are combined, resulting in the generation of an inaccurate mapped image. According to the microscope device 10 by contrast, by treating a state in which observation images are being obtained with a particular magnification as a particular observation condition, even when the magnification is changed temporarily, observation images obtained in that state are not used for the mapped image generation process, making it possible to prevent inaccurate mapped images from being generated.

The scan control unit 37 is a unit that scans the illumination light in a state in which observation images are being obtained by using the confocal laser scanning optical system 2. The scan control unit 37 controls the 2D scanner 11 and the drive motor 15.

The stage control unit 38 is a unit that scans the illumination light in a state in which observation images are being obtained by using the color observation optical system 1. The stage control unit 38 controls the drive motor 17.

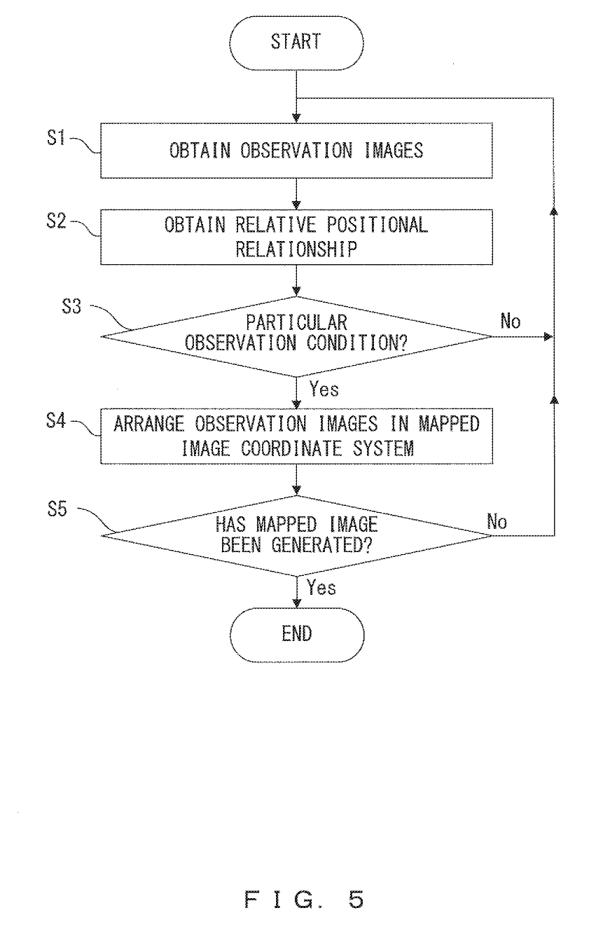

By referring to the flowcharts, explanations will be given for a process sequence of generating a mapped image by using the microscope device 10 having the above configuration. FIG. 5 is a flowchart illustrating a process sequence in which the control device 20 in the microscope device 10 generates a mapped image. The process in FIG. 5 is started after the control device 20 receives an instruction from the observer to start the generation of a mapped image. Also, explanations are given, limiting to an example in which a particular observation condition is that the color camera 4 of the color observation optical system 1 is obtaining observation images.

In step S1, the control device 20 obtains observation images of sample S via the image input/output unit 33. Note that observation images obtained in this example are observation images obtained by either the color observation optical system 1 or the confocal laser scanning optical system 2 in one field of view of the objective 7.

In step S2, the control device 20 obtains a relative positional relationship corresponding to the observation images obtained in step S1, by the relative positional relationship detection unit 35. The process in step S2 is a process corresponding to the observation images obtained in step S1.

In step S3, the image process unit 36 determines whether or not the state is a state in which observation images are being obtained under a particular observation condition, in order to determine whether or not to perform a mapped image generation process by using the observation images obtained by image process unit 36 in step S1. For example, the condition detection unit 34 is in a state in which it can detect a change in the observation condition (i.e., a transition between a particular observation condition and other observation conditions) by monitoring inputs from the observer, and accordingly the current observation condition is understood in the control device 20. When the image process unit 36 determines that the state is a state in which observation images are being obtained under a particular observation condition, the process proceeds to step S4, and when the image process unit 36 determines that the state is not a state in which observation images are being obtained under a particular observation condition, the process returns to step S1 so as to continue picking up images without performing the processes in and after step S4.

In step S4, the observation images obtained in step S1 are arranged on the mapped image coordinate system. Then, the observation images are arranged on the mapped image coordinate system on the basis of the relative positional relationships between the observation images in accordance with the relative relationship between the observation coordinate system and the mapped image coordinate system. In other words, in step S4, a mapped image generation process in which observation images obtained under a particular observation condition are combined so as to generate a mapped image is performed.

In step S5, it is determined whether or not a desired mapped image has been generated. A state in which a desired mapped image has been generated is for example a case when the observer considers the mapped image as being complete and the observer has given a termination instruction. Alternatively, it is a state in which a mapped image corresponding to a scope on the X-Y plane, specified by the observer in advance, of sample S has been generated. When a desired mapped image has not been generated (when the mapped image is in the middle of being generated), the process returns to step S1. When a desired mapped image has been generated, the process in FIG. 5 is terminated.

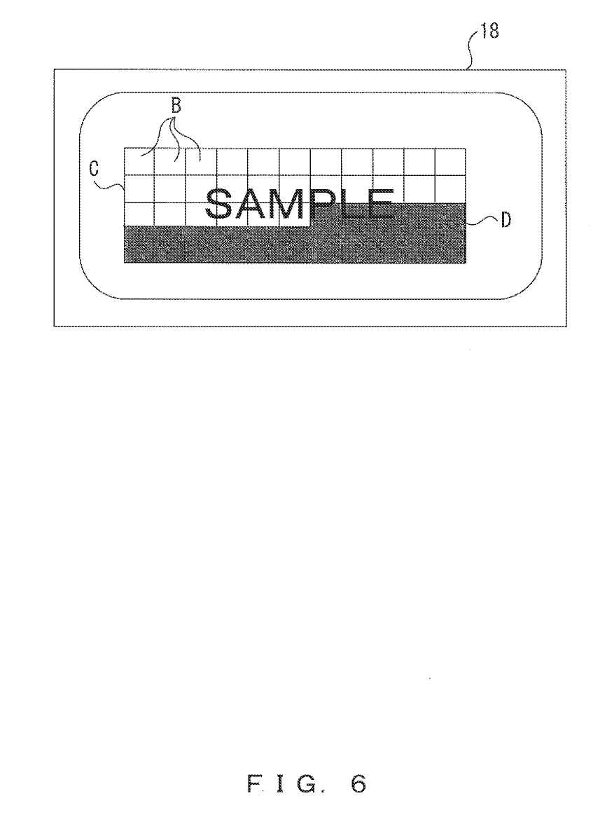

After the process of FIG. 5, the control device 20 outputs the generated mapped image to a display medium. Note that the control device 20 may output in real time, to a display medium, a mapped image that is in the middle of being generated in the process course of FIG. 5, including the course in which the mapped image is generated. FIG. 6 illustrates a state in which a mapped image that is in the middle of being generated is being output to a display medium 18 in real time. Mapped image C is a mapped image which is in the middle of being generated and in which not all the observation images that can be obtained within a scope specified in advance have been arranged, and is constituted of some observation images B that have been obtained. In this state, by promoting the process illustrated in FIG. 5, i.e., by obtaining observation images in region D, which is a region, within a scope specified by the observer in advance, from which observation images have not been obtained, and arranging the observation images on the mapped image coordinate system, the control device 20 generates a desired mapped image. It is also possible to employ a configuration that makes it possible for the observer to understand the progress of the generation of a mapped image via a display medium as described above.

Also, even when a scope in which a mapped image is to be generated is not specified by the observer on sample S, a mapped image that is in the middle of being generated may be output to a display medium in real time, including the course in which the mapped image is updated.

According to the microscope device 10 above, a generation process of a mapped image is performed only under a particular observation condition. Also, a mapped image generation process is automatically halted and restarted in response to transitions between a particular observation condition and observation conditions other than the particular observation condition. Having this function makes it possible to reduce manipulation burdens on the observer accompanying changes in observation conditions during the generation of a mapped image.

Also, as described above, a particular observation condition is an observation condition that is determined by the settings and operation status in the microscope device 10 and can be an arbitrary condition as long as it is appropriate for generating a mapped image. As a variation example of the first embodiment, that stack images are not being obtained may be added to a particular observation condition for example. Stack images are a plurality of observation images obtained while moving the stage 8 by constant steps in the Z directions, and stack images are obtained in order to detect the three-dimensional shape by searching for the focal points. In other words, a state in which stack images are being obtained is not a state appropriate for performing a mapped image generation process on the X-Y plane. Accordingly, the present variation example can prevent a situation where an inaccurate mapped image is generated by using observation images that were obtained in a state with stack image pickup being conducted in the Z directions and that are thus not appropriate for a mapped image generation process.

As another variation example, that autofocus (AF) is not operating may be added to a particular observation condition. The AF conducted in this example is for example passive AF, in which the distance of the focal position of sample S is measured by measuring the contrasts of obtained observation images. Because observation images are obtained at positions that are different in the Z directions while the AF is operating, the state is not a state appropriate for performing a mapped image generation process on the X-Y plane. Accordingly, the present variation example can prevent a situation where an inaccurate mapped image is generated by using observation images obtained during AF, which is not appropriate for mapped image generation processes.

It is also possible for the microscope device 10 to for example once delete a mapped image that has been generated or to store it in the control device 20, when sample S is replaced with a different sample. In other words, the microscope device 10 may be set in such a manner that after a new sample is set as sample S, the state becomes a state in which a new mapped image is generated. Whether or not to replace samples is determined by for example the control device 20 detecting inputs from the observer.

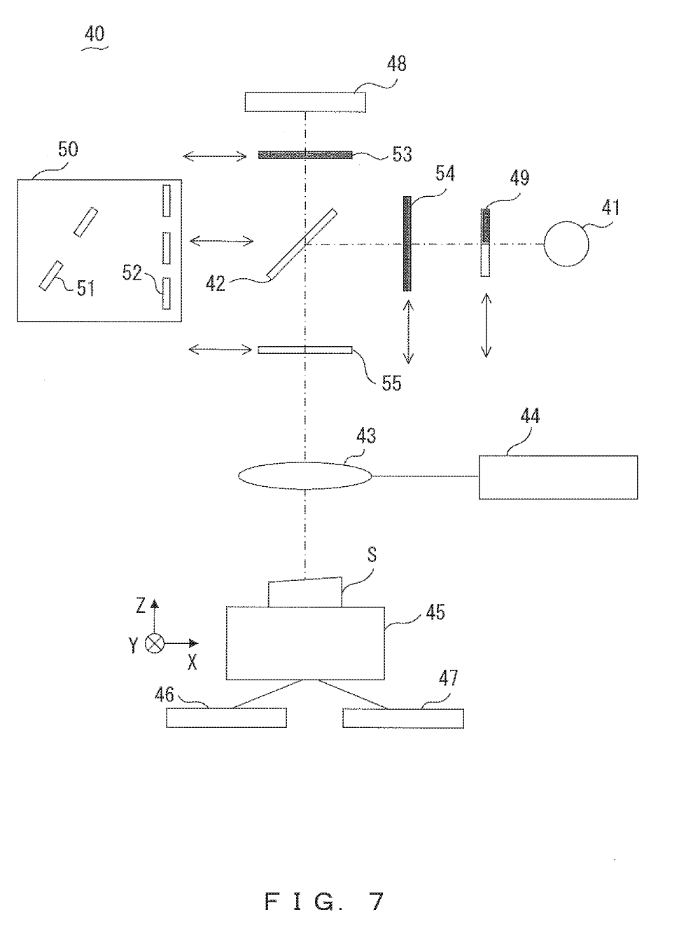

Hereinafter, by referring to the drawings, explanations will be given for a microscope device 40 according to the second embodiment of the present invention. FIG. 7 illustrates a configuration of the microscope device 40.

The microscope device 40 is different from the microscope device 10 in that it does not have a confocal laser scanning optical system and in that it has a configuration that permits the execution of a plurality of microscopies with a color observation optical system.

The microscope device 40 includes a white-light source 41, a removable half mirror 42, an objective 43, drive motors 44 and 47, a stage 45, a stage position detection mechanism 46, a color camera 48, and a control device that is not illustrated. The microscope device 40 further includes, as constituents that can be inserted into and removed from an optical path, a light shielding plate 49 for oblique observations, in which half of a plane containing the optical axis of the illumination light entering from the white-light source 41 is blocked, a dark-field-of-view cube 50 for observations based on dark-field-of-view illumination, a polarizer 54 and an analyzer 53 that are for performing polariscopies and differential interference observations and a DIC prism 55 for performing differential interference observations.

Note that the objective 43 and the stage 45 are similar to the objective 7 and the stage 8 explained in the first embodiment. Also, the drive motors 44 and 47 perform controls that are similar to those performed by the drive motors 15 and 17, and respectively perform movement control of the objective 43 and the stage 45. The stage position detection mechanism 46 is also similar to the stage position detection mechanism 16, obtaining the position information of the stage 45.

Also, the control device (not illustrated) that is included in the microscope device 40 is a computer having a functional configuration that is similar to that of the control device 20. Also, the control device (not illustrated) controls the insertion and removal of the constituents that can be inserted and removed, when it performs the switching operation of microscopies, which will be described later.

The microscope device 40 can perform a bright-field-of-view observation, a dark-field-of-view observation, an oblique observation, a polariscopy and a differential interference observation.

Bright-field-of-view observations are performed in a state in which only the half mirror 42 is used from among the above constituents that can be inserted and removed. In other words, it is similar to observations performed by using the color observation optical system 1 of the microscope device 10.

Dark-field-of-view observations are performed in a state in which the dark-field-of-view cube 50 is inserted instead of the half mirror 42 and the other constituents that can be inserted and removed are removed from the optical path. The dark-field-of-view cube 50 includes a light shielding plate 52 having an opening formed at a position apart from the axis of the illumination light and a light shielding plate 51 having an opening formed at the center. The light shielding plate 52 may be a circular opening. For a dark-field-of-view observation, the illumination light issued from the white-light source 41 only passes through the opening of the light shielding plate 52, and is diagonally cast on sample S on the stage 45 via the light shielding plate 51 and the objective 43. From among the beams of light reflected by sample S, light that has passed through the opening of the light shielding plate 51 reaches the color camera 48. Light passing through the opening of the light shielding plate 51 is light that results from the illumination light being scattered after being diagonally cast on sample S, and thus a dark-field-of-view image can be obtained by the color camera 48 detecting that scattered light.

Oblique observations are performed in a state in which the light shielding plate 49 for an oblique observation and the half mirror 42 are inserted and the other constituents that can be inserted and removed are removed from the optical path. For an oblique observation, half of the illumination light entering from the white-light source 41 is blocked by the light shielding plate 49, the illumination light enters only half of the pupil of the objective 7, and oblique illumination is provided to sample S. Oblique illumination generates shadow, making it possible to obtain a 3D observation image.

Polariscopies are performed in a state in which the polarizer 54, the analyzer 53, and the half mirror 42 are inserted and the other constituents that can be inserted and removed are removed from the optical path. The polarizer 54 and the analyzer 53 are arranged in such a manner that they have vibration directions that are orthogonal to each other. Polariscopies make it possible to obtain an observation image having a contrast in accordance with the polarization characteristics of sample S.

Differential interference observations are performed in a state in which the polarizer 54, the analyzer 53, the DIC prism 55 and the half mirror 42 are inserted and the other constituents that can be inserted and removed are removed from the optical path. The DIC prism 55 has its arrangement angle adjusted so that appropriate retardation is caused. In other words, in a differential interference observation, two beams of polarized light split by the DIC prism 55 make it possible to cast two beams of polarized light to slightly different positions on sample S, and by utilizing the interference between those two beams of polarized light, a 3D observation image can be obtained.

In the microscope device 40 having the above configuration, for example a mapped image generation process in which a mapped image is generated by using observation images obtained during a dark-field-of-view observation is performed. Meanwhile, there is a case where the microscopy is switched to a different microscopy (such as dark-field-of-view observations, oblique observations, etc.) that can be performed by the microscope device 40 during a bright-field-of-view so as to obtain observation images of sample S.

The present embodiment is characterized in that a particular observation condition is set to include that a bright-field-of-view observation is being performed. By setting a particular observation condition as described above, even in a case when the microscopy is temporarily changed to a different microscopy during the generation of a mapped image in a bright-field-of-view observation so as to obtain observation images of sample S, observation images obtained in a state in which a microscopy other than a bright-field-of-view observation is used are not used for the mapped image generation process, preventing an inaccurate mapped image from being generated.

Also, the control device automatically determines whether or not images are appropriate for generating a mapped image so as to perform a mapped image generation process without the observer doing so, by a configuration that performs a mapped image generation process under a particular observation condition. This can reduce manipulation burdens on the observer. This effect is similar to that explained in relation to the microscope device 10 of the first embodiment.

As described above, the present invention can reduce manipulation burdens on the observer that accompany changes in an observation condition during the generation of a mapped image.

The above described embodiments are specific examples for facilitating understanding of the invention and the present invention is not limited to these embodiments. The above microscope devices, storage media storing a program and observation methods can receive various modifications and changes without departing from the present invention described in the claims.

What is claimed is:

1. A microscope device comprising:
an image pickup device that obtains an observation image of a sample; and
an image process device that performs, in a state in which the image pickup device is obtaining the observation images under a particular observation condition, a mapped image generation process in which the plurality of observation images obtained under the particular observation condition are combined so as to generate a mapped image, halts the mapped image generation process when the state transitions to a state that is an observation condition other than the particular observation condition from the state in which the image pickup device is obtaining the observation images under the particular observation condition, and restarts the mapped image generation process when the state again transitions to a state in which the image pickup device is obtaining the observation images under the particular observation condition.

2. The microscope device according to claim 1, further comprising
an objective, and
a relative positional relationship detection device that detects a relative positional relationship between the sample and the objective, wherein
the image process device performs the mapped image generation process on the basis of the observation images, the relative positional relationship, and a relative relationship between an observation coordinate system, which is a coordinate system defining the relative positional relationship, and a mapped image coordinate system.

3. The microscope device according to claim 1, further comprising
a color observation optical system, and
a confocal laser scanning optical system, wherein
the image pickup device includes a first image pickup device that obtains a first observation image, which is the observation image of the sample through the color observation optical system, and a second image pickup device that obtains a second observation image through the confocal laser scanning optical system.

4. The microscope device according claim 3, wherein
the particular observation condition includes that the first image pickup device is obtaining a first observation image, which is the observation image.

5. The microscope device according to claim 1, wherein
the particular observation condition includes that the observation image is being obtained with a particular magnification.

6. The microscope device according to claim 1, wherein
the particular observation condition includes that a bright-field-of-view observation is being performed.

7. The microscope device according to claim 1, further comprising
a detection device that detects that the observation condition is the particular observation condition.

8. A non-transitory storage medium having stored therein a program that causes a computer to execute a process of making an image pickup device and an image process device operate so that
the image pickup device obtains an observation image of a sample, and
the image process device performs, in a state in which the image pickup device is obtaining the observation images under a particular observation condition, a mapped image generation process in which the plurality of observation images obtained under the particular observation condition are combined so as to generate a mapped image, halts the mapped image generation process when the state transitions to a state that is an observation condition other than the particular observation condition from the state in which the image pickup device is obtaining the observation images under the particular observation condition, and restarts the mapped image generation process when the state again transitions to a state in which the image pickup device is obtaining the observation images under the particular observation condition.

9. An observation method comprising:
obtaining an observation image of a sample; and
performing, in a state in which the observation images are being obtained under a particular observation condition, a mapped image generation process in which the plurality of observation images obtained under the particular observation condition are combined so as to generate a mapped image, halting the mapped image generation process when the state transitions to a state that is an observation condition other than the particular observation condition from the state in which the image pickup device is obtaining the observation images under the particular observation condition, and restarting the mapped image generation process when the state again transitions to a state in which the observation images are being obtained under the particular observation condition.
